(19) United States
(12) Patent Application Publication
(10) Pub. No.: US 2013/0098463 A1
(43) Pub. Date: Apr. 25, 2013

(54) METERLESS HYDRAULIC SYSTEM HAVING SHARING AND COMBINING FUNCTIONALITY

(71) Applicants: Jeffrey L. KUEHN, Metamora, IL (US); Brad A. EDLER, Waterloo, IL (US); Jeremy T. PETERSON, Washington, IL (US); Michael T. VERKUILEN, Metamora, IL (US)

(72) Inventors: Jeffrey L. KUEHN, Metamora, IL (US); Brad A. EDLER, Waterloo, IL (US); Jeremy T. PETERSON, Washington, IL (US); Michael T. VERKUILEN, Metamora, IL (US)

(21) Appl. No.: 13/278,491

(22) Filed: Oct. 21, 2011

(51) Int. Cl. F17D 3/00; F17D 1/08

(52) U.S. Cl. 137/12; 137/563

(57) ABSTRACT

A hydraulic system is disclosed. The hydraulic system may have a unidirectional variable displacement first pump, a first hydraulic actuator connected to the first pump via a closed-loop first circuit, a unidirectional variable displacement second pump, and a second hydraulic actuator connected to the second pump via a closed-loop second circuit. The hydraulic system may also have a third pump selectively connectable in closed-loop manner to the first or second circuits, and a first valve disposed between the first hydraulic actuator and the first pump and configured to selectively direct fluid from the first circuit to the second and third pumps.

### TECHNICAL FIELD

The present disclosure relates generally to a hydraulic system and, more particularly, to a meterless hydraulic system having flow sharing and combining functionality.

### BACKGROUND

A conventional open-loop hydraulic system includes a pump that draws low-pressure fluid from a tank, pressurizes the fluid, and makes the pressurized fluid available to multiple different actuators for use in moving the actuators. In this arrangement, a speed of each actuator can be independently controlled by selectively throttling (i.e., restricting) a flow of the pressurized fluid from the pump into each actuator. For example, to move a particular actuator at a high speed, the flow of fluid from the pump into the actuator is restricted by only a small amount. In contrast, to move the same or another actuator at a low speed, the restriction placed on the flow of fluid is increased. Although adequate for many applications, the use of fluid restriction to control actuator speed can result in flow losses that reduce an overall efficiency of a hydraulic system.

An alternative type of hydraulic system is known as a meterless or closed-loop hydraulic system. A meterless hydraulic system generally includes a pump connected in closed-loop fashion to a single actuator or to a pair of actuators operating in tandem. During operation, the pump draws fluid from one chamber of the actuator(s) and discharges pressurized fluid to an opposing chamber of the same actuator(s). To move the actuator(s) at a higher speed, the pump discharges fluid at a faster rate. To move the actuator with a lower speed, the pump discharges the fluid at a slower rate. A meterless hydraulic system is generally more efficient than a conventional hydraulic system because the speed of the actuator(s) is controlled through pump operation as opposed to fluid restriction. That is, the pump is controlled to only discharge as much fluid as is necessary to move the actuator(s) at a desired speed, and no throttling of a fluid flow is required.

An exemplary meterless hydraulic system is disclosed in U.S. Patent Publication 2008/0250785 of Griswold that published on Oct. 16, 2008 (the '785 publication). In the '785 publication, a multi-actuator meterless-type hydraulic system is described that has flow combining functionality. The hydraulic system includes a first circuit having a first hydraulic actuator connected to a first pump in a closed-loop manner, and a second circuit having a second hydraulic actuator connected to a second pump in a closed manner. The hydraulic system also includes a third pump connected in an open-loop manner to the first and second circuits to provide additional flow to the first and second circuits.

Although an improvement over existing meterless hydraulic systems, the meterless hydraulic system of the '785 publication described above may still be less than optimal. In particular, because the third pump is connected to the first and second circuits in an open-loop manner, excessive pumping losses may still be realized.

The hydraulic system of the present disclosure is directed toward solving one or more of the problems set forth above and/or other problems of the prior art.

### SUMMARY

In one aspect, the present disclosure is directed to a hydraulic system. The hydraulic system may include a unidirectional variable displacement first pump, a first hydraulic actuator connected to the first pump via a closed-loop first circuit, a unidirectional variable displacement second pump, and a second hydraulic actuator connected to the second pump via a closed-loop second circuit. The hydraulic system may also include a third pump selectively connectable in closed-loop manner to the first or second circuits, and a first valve disposed between the first hydraulic actuator and the first pump and configured to selectively direct fluid from the first circuit to the second and third pumps.

In another aspect, the present disclosure is directed to a method of operating a hydraulic system. The method may include pressurizing fluid with a first pump, directing pressurized fluid from the first pump to a first hydraulic actuator via a closed-loop first circuit, pressurizing fluid with a second pump, and directing pressurized fluid from the second pump to a second hydraulic actuator via a closed-loop second circuit. The method may also include pressurizing fluid with a third pump, and selectively directing pressurized fluid from the third pump to the first or second circuits in closed-loop manner. The method may further include selectively directing fluid from the first circuit to the second and third pumps.

### BRIEF DESCRIPTION OF THE DRAWINGS

FIG. 1 is a pictorial illustration of an exemplary disclosed machine; and

FIG. 2 is a schematic illustration of an exemplary disclosed hydraulic system that may be used in conjunction with the machine of FIG. 1.

### DETAILED DESCRIPTION

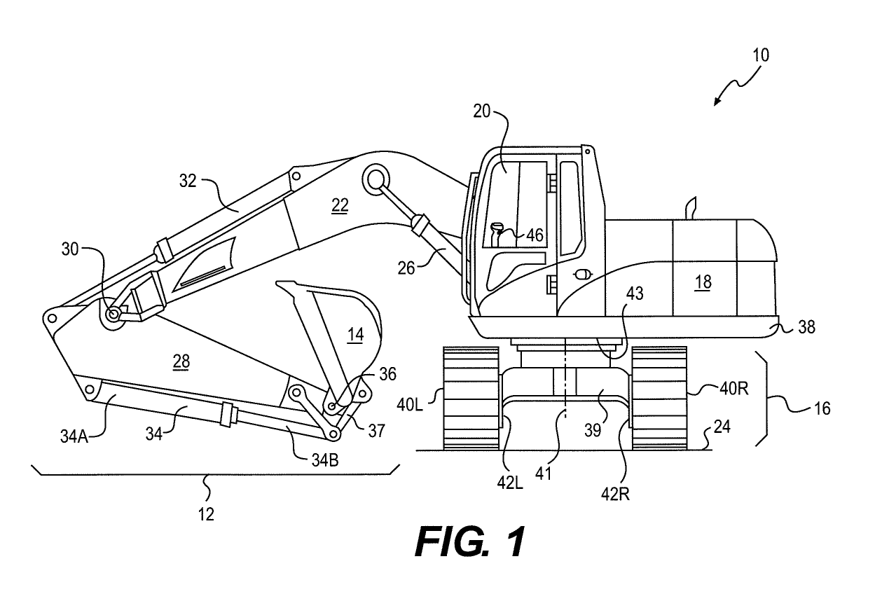

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as an excavator (shown in FIG. 1), a dozer, a loader, a backhoe, a motor grader, a dump truck, or another earth moving machine. Machine 10 may include an implement system 12 configured to move a work tool 14, a drive system 16 for propelling machine 10, a power source 18 that provides power to implement system 12 and drive system 16, and an operator station 20 situated for manual control of implement system 12, drive system 16, and/or power source 18.

Implement system 12 may include a linkage structure acted on by linear and rotary fluid actuators to move work tool 14. For example, implement system 12 may include a boom 22 that is vertically pivotal about a horizontal axis (not shown) relative to a work surface 24 by a pair of adjacent, double-acting, hydraulic cylinders 26 (only one shown in FIG. 1). Implement system 12 may also include a stick 28 that is vertically pivotal about a horizontal axis 30 by a single, double-acting, hydraulic cylinder 32. Implement system 12 may further include a single, double-acting, hydraulic cylinder 34 that is operatively connected between stick 28 and work tool 14 to pivot work tool 14 vertically about a horizontal pivot axis 36. In the disclosed embodiment, hydraulic cylinder 34 is connected at a head-end 34A to a portion of stick 28 and at an opposing rod-end 34B to work tool 14 by way of a power link 37. Boom 22 may be pivotally connected at a base end to a body 38 of machine 10. Body 38 may be connected to an undercarriage 39 to swing about a vertical axis 41 by a hydraulic swing motor 43. Stick 28 may pivotally connect a distal end of boom 22 to work tool 14 by way of axes 30 and 36.

Numerous different work tools 14 may be attachable to a single machine 10 and operator controllable. Work tool 14 may include any device used to perform a particular task such as, for example, a bucket (shown in FIG. 1), a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10 and to swing in the horizontal direction about pivot axis 41, work tool 14 may alternatively or additionally rotate relative to stick 28, slide, open and close, or move in any other manner known in the art.

Drive system 16 may include one or more traction devices powered to propel machine 10. In the disclosed example, drive system 16 includes a left track 40L located on one side of machine 10, and a right track 40R located on an opposing side of machine 10. Left track 40L may be driven by a left travel motor 42L, while right track 40R may be driven by a right travel motor 42R. It is contemplated that drive system 16 could alternatively include traction devices other than tracks, such as wheels, belts, or other known traction devices. Machine 10 may be steered by generating a speed and/or rotational direction difference between left and right travel motors 42L, 42R, while straight travel may be facilitated by generating substantially equal output speeds and rotational directions of left and right travel motors 42L, 42R.

Power source 18 may embody an engine such as, for example, a diesel engine, a gasoline engine, a gaseous fuel-powered engine, or another type of combustion engine known in the art. It is contemplated that power source 18 may alternatively embody a non-combustion source of power such as a fuel cell, a power storage device, or another source known in the art. Power source 18 may produce a mechanical or electrical power output that may then be converted to hydraulic power for moving the linear and rotary actuators of implement system 12.

Operator station 20 may include devices that receive input from a machine operator indicative of desired maneuvering. Specifically, operator station 20 may include one or more operator interface devices 46, for example a joystick (shown in FIG. 1), a steering wheel, or a pedal, that are located proximate an operator seat (not shown). Operator interface devices 46 may initiate movement of machine 10, for example travel and/or tool movement, by producing displacement signals that are indicative of desired machine maneuvering. As an operator moves interface device 46, the operator may affect a corresponding machine movement in a desired direction, with a desired speed, and/or with a desired force.

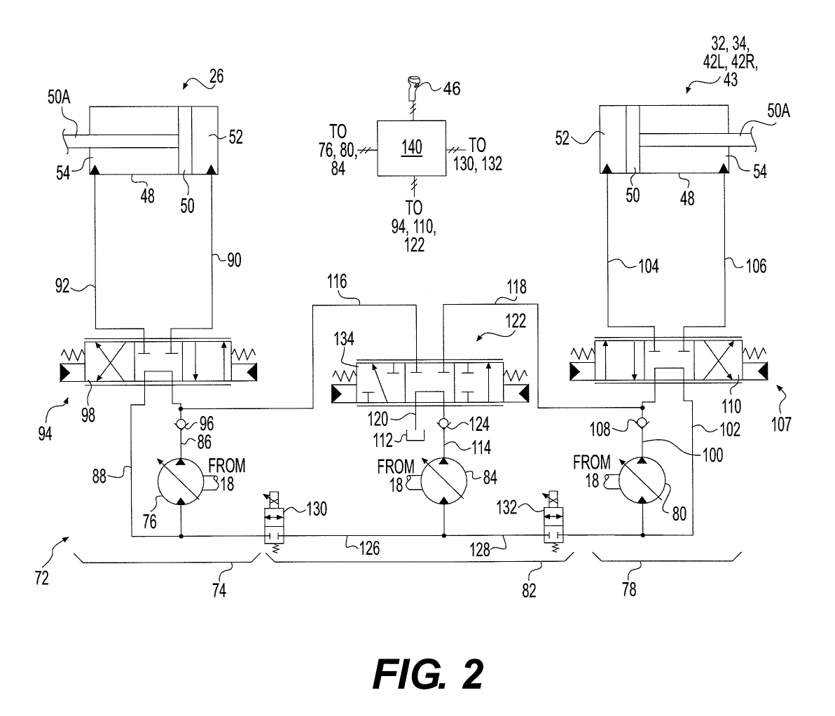

Two exemplary hydraulic actuators are shown in the schematic of FIG. 2. It should be noted that, while only two linear actuators are shown, the depicted actuators may represent any one or more of the linear actuators (e.g., hydraulic cylinders 26, 32, 34) or the rotary actuators (left travel, right travel, or swing motors 42L, 42R, 43) of machine 10.

The hydraulic actuators, if embodied as a linear actuator, may each include a tube 48 and a piston assembly 50 arranged within tube 48 to form a first chamber 52 and an opposing second chamber 54. In one example, a rod portion 50A of piston assembly 50 may extend through an end of second chamber 54. As such, each second chamber 54 may be considered the rod-end chamber of the respective actuator, while each first chamber 52 may be considered the head-end chamber. First and second chambers 52, 54 of each hydraulic actuator may be selectively supplied with pressurized fluid from one or more pumps and drained of the pressurized fluid to cause piston assembly 50 to displace within tube 48, thereby changing the effective length of the actuator to move work tool 14. A flow rate of fluid into and out of first and second chambers 52, 54 may relate to a translational velocity of each actuator, while a pressure differential between first and second chambers 52, 54 may relate to a force imparted by each actuator on work tool 14.

The hydraulic actuators, if embodied as rotary actuators, may function in a similar manner. That is, each rotary actuator may also include first and second chambers located to either side of a pumping mechanism such as an impeller, plunger, or series of pistons. When the first chamber is filled with pressurized fluid from one or more pumps and the second chamber is simultaneously drained of fluid, the pumping mechanism may be urged to rotate in a first direction by a pressure differential across the pumping mechanism. Conversely, when the first chamber is drained of fluid and the second chamber is simultaneously filled with pressurized fluid, the pumping mechanism may be urged to rotate in an opposite direction by the pressure differential. The flow rate of fluid into and out of the first and second chambers may determine a rotational velocity of each actuator, while a magnitude of the pressure differential across the pumping mechanism may determine an output torque. The rotary actuators could be fixed- or variable-displacement type motors, as desired.

Machine 10 may include a hydraulic system 72 having a plurality of fluid components that cooperate with the hydraulic actuators to move work tool 14 and machine 10. In particular, hydraulic system 72 may include, among other things, a closed-loop first circuit 74 fluidly connecting a first pump 76 with a first hydraulic actuator (e.g., hydraulic cylinder 26) of machine 10, a closed-loop second circuit 78 fluidly connecting a second pump 80 with a second hydraulic actuator (e.g., hydraulic cylinders 32 or 34, or left-travel, right-travel, or swing motors 42L, 42R, 43), and a third circuit 82 selectively connecting a third pump 84 with first or second circuits 74, 78. It is contemplated that hydraulic system 72 may include additional and/or different circuits or components, if desired, such as a charge circuit having one or more makeup valves, relief valves, pressure sources, and/or storage devices; switching valves; pressure-compensating valves, and other circuits or valves known in the art.

First circuit 74 may include multiple different passages that fluidly connect first pump 76 to the first hydraulic actuator and, in some configurations, to the other actuators of machine 10 in a parallel, closed-loop manner. For example, first pump 76 may be connected to the first hydraulic actuator via a discharge passage 86, an intake passage 88, a head-end passage 90, and a rod-end passage 92. A first control valve 94 may be disposed between discharge and intake passages 86, 88 and head- and rod-end passages 90, 92 to control fluid flow through first circuit 74. A first check valve 96 may be disposed within discharge passage 86 to help ensure a unidirectional flow of fluid through first pump 76.

First control valve 94 may include a pilot-operated spool element 98 movable between three distinct positions. When spool element 98 is in the first position (right-most position shown in FIG. 2), discharge passage 86 may be fluidly connected with head-end passage 90, while intake passage 88 may be fluidly connected with rod-end passage 92 such that fluid from first pump 76 flows through the first hydraulic actuator in a first direction causing the first hydraulic actuator to move in a first direction (e.g., in an extending direction). When spool element 98 is in the second position (middle position shown in FIG. 2), discharge passage 86 may be fluidly connected with intake passage 88 such that the fluid within first circuit 74 (e.g., from first pump 76) bypasses the first hydraulic actuator. When spool element 98 is in the third position (left-most position shown in FIG. 2), discharge passage 86 may be fluidly connected with rod-end passage 92, while intake passage 88 may be fluidly connected with head-end passage 90 such that fluid from first pump 76 flows through the first hydraulic actuator in a second direction opposite the first direction causing the first hydraulic actuator to move in a second direction (e.g., in a retracting direction).

Spool element 98 may be spring-biased to the second position, and pilot-operated to move to any position between the first, second, and third positions such that some fluid from first pump 76 may flow through the first hydraulic actuator in a particular direction, while the remaining fluid from first pump 76 may bypass the first hydraulic actuator. When spool element 98 is in a position between the first and second positions or between the second and third positions (i.e., in an in-between position), an operator of machine 10 may experience what is commonly known as an “open-center” feel associated with control of the first hydraulic actuator. That is, when the operator causes movement of spool element 98 to an in-between position, the first hydraulic actuator may be caused to move until a load on work tool 14 equals a force generated on the first hydraulic actuator by fluid from first pump 76, at which time the first hydraulic actuator may stop moving. To then cause the first hydraulic actuator to continue movement, the operator would be required to cause spool element 98 to move further towards one of the first and third positions. The “open-center” feel provides enhanced control for the operator over work tool 14.

Second circuit 78 may include multiple different passages that fluidly connect second pump 80 to the second hydraulic actuator and, in some configurations, to the other actuators of machine 10 in a parallel, closed-loop manner. For example, second pump 80 may be connected to the second hydraulic actuator via a discharge passage 100, an intake passage 102, a head-end passage 104, and a rod-end passage 106. A second control valve 107 may be disposed between discharge and intake passages 100, 102 and head- and rod-end passages 104, 106 to control fluid flow through second circuit 78. A second check valve 108 may be disposed within discharge passage 100 to help ensure a unidirectional flow of fluid through second pump 80.

Second control valve 107 may be substantially identical to first control valve 94, and include a pilot-operated spool element 110 movable between three distinct positions. When spool element 110 is in the first position (right-most position shown in FIG. 2), discharge passage 100 may be fluidly connected with head-end passage 104, while intake passage 102 may be fluidly connected with rod-end passage 106 such that fluid from second pump 80 flows through the second hydraulic actuator in a first direction causing the second hydraulic actuator to move in a first direction (e.g., in an extending direction). When spool element 110 is in the second position (middle position shown in FIG. 2), discharge passage 100 may be fluidly connected with intake passage 102 such that the fluid within second circuit 78 (e.g., from second pump 80) bypasses the second hydraulic actuator. When spool element 110 is in the third position (left-most position shown in FIG. 2), discharge passage 100 may be fluidly connected with rod-end passage 106, while intake passage 102 may be fluidly connected with head-end passage 104 such that fluid from second pump 80 flows through the second hydraulic actuator in a second direction opposite the first causing the second hydraulic actuator to move in a second direction (e.g., in a retracting direction). Spool element 110 may be substantially identical to spool element 98.

Third circuit 82 may include multiple different passages that fluidly connect third pump 84 to first circuit 74, to second circuit 78, and/or to a low-pressure tank. For example, third pump 84 may be connected to discharge passage 86 of first circuit 74, at a location downstream of first check valve 96, via a common discharge passage 114 and a first-circuit passage 116. Alternatively, third pump 84 may be connected to discharge passage 100 of second circuit 78, at a location downstream of second check valve 108, via common discharge passage 114 and a second-circuit passage 118. Finally, third pump 84 may be connected to low-pressure tank 112 (or alternatively to a charge circuit) via common discharge passage 114 and a return passage 120. A third control valve 122 may be disposed between common discharge passage 114 and first-circuit passage 116, second circuit passage 118, and return passage 120 to control fluid flow through third circuit 82. A third check valve 124 may be disposed within common discharge passage 114 to help ensure a unidirectional flow of fluid through third pump 84.

Third pump 84 may be configured to draw fluid from one or both of first and second circuits 74, 78 (or alternatively or additionally from a charge circuit, if desired). Specifically, third pump 84 may be connected to intake passage 88 of first circuit 74 via a first intake passage 126, and connected to intake passage 102 of second circuit 78 via a second intake passage 128. A first isolation valve 130 may be disposed within first intake passage 126, while a second isolation valve 132 may be disposed within second intake passage 128.

Third control valve 122, like first and second control valves 94, 107 may be a four-way valve having a pilot-operated spool element 134 movable between three distinct positions. When spool element 134 is in the first position (left-most position shown in FIG. 2), common discharge passage 114 may be fluidly connected with first-circuit passage 116, while second-circuit and return passages 118, 120 may be substantially isolated from common discharge passage 114. When spool element 134 is in the second position (middle position shown in FIG. 2), common discharge passage 114 may be fluidly connected with tank 112, while first- and second-circuit passages 116, 118 may be substantially isolated from common discharge passage 114. When spool element 134 is in the third position (right-most position shown in FIG. 2), common discharge passage 114 may be fluidly connected with second-circuit passage 118, while first-circuit and return passages 116, 120 may be substantially isolated from common discharge passage 114.

Spool element 134 may be spring-biased to the second position, and pilot-operated to move to any position between the first, second, and third positions such that some fluid from third pump 84 may flow into tank 112, while the remaining fluid from third pump 84 may flow either into first circuit 74 or second circuit 78. Spool element 134 may be moved to the second position, or to a position between the first and second positions or between the second and third positions (i.e., to an in-between position) during a regeneration event, when an amount of fluid from the first or second circuits 74, 78 directed to third pump 84 is greater than an amount of fluid required from third pump 84 by first or second circuits 74, 78. When high-pressure fluid passes through third pump 84 and into tank 112, the power required to drive third pump 84 may be reduced. In fact, in some situations, third pump 84 may even be driven as a motor by the fluid, such that energy within the pressurized fluid may be recaptured and returned to power source 18 via third pump 84.

First and second isolation valves 130, 132 may each be configured to move between a flow-passing position and a flow-blocking position (shown in FIG. 2). First and second isolation valves 130, 132 may be spring-biased toward the flow-blocking position, and solenoid-operated to move to the flow-passing position. It is contemplated that, in some embodiments, first and/or second isolation valves 130, 132 may be moved to any position between the flow-passing and flow-blocking positions, if desired, to facilitate pressure control within any of first, second, and third circuits 74, 78, 82.

First, second, and third pumps 76, 80, 84 may each be substantially identical variable-displacement type pumps that are controlled to draw fluid from the actuators of machine 10 and discharge the fluid at a specified elevated pressure back to the actuators in a single direction (i.e., pumps 76,80, 84 may be unidirectional pumps). Pumps 76, 80, 84 may each include a stroke-adjusting mechanism, for example a swashplate, a position of which is hydro-mechanically adjusted based on, among other things, a desired speed of the actuators to thereby vary an output (e.g., a discharge rate. The displacement of pumps 76, 80, 84 may be adjusted from a zero displacement position at which substantially no fluid is discharged, to a maximum displacement position at which fluid is discharged at a maximum rate into discharge passages 86, 100, 114, respectively. Pumps 76, 80, 84 may be drivably connected to power source 18 of machine 10 by, for example, a countershaft, a belt, or in another suitable manner. Alternatively, pumps 76, 80, 84 may be indirectly connected to power source 18 via a torque converter, a gear box, an electrical circuit, or in any other manner known in the art. It is contemplated that pumps 76, 80, 84 may be connected to power source 18 in tandem (e.g., via the same shaft) or in parallel (e.g., via a gear train), as desired.

During operation of machine 10, the operator may utilize interface device 46 to provide a signal that identifies a desired movement of the various linear and/or rotary actuators to a controller 140. Based upon one or more signals, including the signal from interface device 46 and, for example, signals from various pressure sensors (not shown) and/or position sensors (not shown) located throughout hydraulic system 72, controller 140 may command movement of the different valves and/or displacement changes of the different pumps and motors to advance a particular one or more of the linear and/or rotary actuators to a desired position in a desired manner (i.e., at a desired speed and/or with a desired force).

Controller 140 may embody a single microprocessor or multiple microprocessors that include components for controlling operations of hydraulic system 72 based on input from an operator of machine 10 and based on sensed or other known operational parameters. Numerous commercially available microprocessors can be configured to perform the functions of controller 140. It should be appreciated that controller 140 could readily be embodied in a general machine microprocessor capable of controlling numerous machine functions. Controller 140 may include a memory, a secondary storage device, a processor, and any other components for running an application. Various other circuits may be associated with controller 140 such as power supply circuitry, signal conditioning circuitry, solenoid driver circuitry, and other types of circuitry.

### INDUSTRIAL APPLICABILITY

The disclosed hydraulic system may be applicable to any machine where improved hydraulic efficiency is desired. The disclosed hydraulic system may provide for improved efficiency through the selective use of closed-loop technology, flow-sharing, and flow-combining. Operation of hydraulic system 72 will now be described.

During operation of machine 10, an operator located within station 20 may command a particular motion of work tool 14 in a desired direction and at a desired velocity by way of interface device 46. One or more corresponding signals generated by interface device 46 may be provided to controller 140 indicative of the desired motion, along with machine performance information, for example sensor data such as pressure data, position data, speed data, pump or motor displacement data, and other data known in the art.

For example, in response to the signals from interface device 46 indicative of a desire to lift boom 22, and based on the machine performance information, controller 140 may generate control signals directed to the stroke-adjusting mechanism of first pump 76 and/or to first control valve 94. To drive the first hydraulic actuator (e.g., hydraulic cylinders 26) at an increasing speed in an extending direction, controller 140 may generate a control signal that causes first pump 76 of first circuit 74 to increase its displacement and discharge pressurized fluid into discharge passage 86 at a greater rate and/or a control signal that causes spool element 98 of first control valve 94 to move toward the first position. As described above, when spool element 98 moves toward the first position, discharge passage 86 may be increasingly fluidly communicated with head-end passage 90 and rod-end passage 92 may be increasingly fluidly communicated with intake passage 88. When fluid from first pump 76 is directed into first chamber 52, return fluid from second chamber 54 of the first hydraulic actuator and/or from the other linear or rotary actuators of first circuit 74 may flow back into first pump 76 in closed-loop manner. First isolation valve 130 may be in its flow-blocking position during normal extensions of the first hydraulic actuator. Extension of the second hydraulic actuator shown in FIG. 2 may be initiated in a similar manner.

To drive the first hydraulic actuator at an increasing speed in a retracting direction (e.g., to lower boom 22), controller 140 may generate a control signal that causes first pump 76 of first circuit 74 to increase its displacement and discharge pressurized fluid into discharge passage 86 at a greater rate and/or a control signal that causes spool element 98 of first control valve 94 to move toward the third position. As described above, when spool element 98 moves toward the third position, discharge passage 86 may be increasingly fluidly communicated with rod-end passage 92 and head-end passage 90 may be increasingly fluidly communicated with intake passage 88. When fluid from first pump 76 is directed into second chamber 54, return fluid from first chamber 52 of the first hydraulic actuator and/or from the other linear or rotary actuators of first circuit 74 may flow back into first pump 76 in closed-loop manner. First isolation valve 130 may be in its flow-blocking position during normal retractions of the first hydraulic actuator. Retraction of the second hydraulic actuator shown in FIG. 2 may be initiated in a similar manner.

During normal extensions of the first or second hydraulic actuators, more fluid may be required within the respective head-end passages 90, 104, than can be supplied by first and second pumps 76, 80 into first and second discharge passages 86, 100. That is, the respective rates of fluid flow into and out of the hydraulic actuators (if embodied as linear actuators) during extension and retraction may not be equal. In particular, because of the location of rod portion 50A within second chamber 54, piston assembly 50 may have a reduced pressure area within second chamber 54, as compared with a pressure area within first chamber 52. Accordingly, during retraction of the hydraulic actuators, more fluid may be forced out of first chamber 52 than can be consumed by second chamber 54 and, during extension, more hydraulic fluid may be consumed by first chamber 52 than is forced out of second chamber 54. In order to accommodate the additional fluid required during extension, the output of third pump 84 may be selectively directed into first and second circuits 74, 78.

For example, during extension of the first hydraulic actuator shown in FIG. 2, controller 140 may generate a control signal that causes third pump 84 of third circuit 82 to increase its displacement and discharge pressurized fluid into common discharge passage 114 at a greater rate, and/or a control signal that causes spool element 134 of third control valve 122 to move toward the first position. As described above, when spool element 134 moves toward the first position, common discharge passage 114 may be increasingly fluidly communicated with first-circuit passage 116 such that fluid flows from third circuit 82 into first circuit 74 at a greater rate. When fluid from third pump 84 is directed into first circuit 74, makeup fluid may be supplied to third pump 84 either from a charge circuit (not shown) or from second circuit 78, as conditions allow (e.g., from second circuit 78 during retraction of the second hydraulic actuator, otherwise from the charge circuit).

During retraction of the first hydraulic actuator shown in FIG. 2, controller 140 may generate a control signal that causes third pump 84 of third circuit 82 to increase its displacement and discharge pressurized fluid into common discharge passage 114 at a greater rate and/or a control signal that causes spool element 134 of third control valve 122 to move toward the third position. As described above, when spool element 134 moves toward the third position, common discharge passage 114 may be increasingly fluidly communicated with second-circuit passage 118 such that fluid flows from third circuit 82 into second circuit 78 at a greater rate. When fluid from third pump 84 is directed into second circuit 78, makeup fluid may be supplied to third pump 84 either from a charge circuit (not shown), from first circuit 74 during extension of the second actuator, and/or from second circuit 78 during retraction of the second actuator, as conditions allow.

First and/or second circuits 74, 78 may also be configured to selectively direct fluid to the other circuits under particular conditions. For example, during retraction of the first hydraulic actuator, while first pump 76 is supplying pressurized fluid to second chamber 54, first chamber 52 may be discharging fluid in excess of the amount being drawn into first pump 76. At this time, the excess fluid may be directed to second or third pumps 80, 84 via first or first and second intake passages 126, 128. At this time, one or both of first and second isolation valves 130, 132 may moved to their flow-passing positions, depending on the circuit(s) in need of the pressurized fluid. This fluid, particularly if highly-pressurized (as may be the case during an overrunning condition), may help reduce the power consumption of the fluid-receiving pump(s) and/or even be used to drive the fluid-receiving pump(s) as a motor to return energy back to power source 18. If, during the discharge of pressurized fluid from first circuit 74, second circuit 78 does not have need for pressurized fluid, the fluid may be directed through third pump 84 and into tank 112 via common discharge passage 114, third control valve 122, and return passage 120. Second isolation valve 132 may be moved to the flow-blocking position at this time. Because common discharge passage 114 may be connected to tank 112 when receiving fluid from first and/or second circuits 74, 78, the pressure differential across third pump 84 may be large, allowing for a large amount of energy to be recuperated from the pressurized fluid. The discharge of excess fluid from second circuit 78 may function in a similar manner.

It may be possible in some situations for first circuit 74 to discharge fluid to third circuit 82 at the same time that third circuit 82 is discharging fluid to second circuit 78. In this situation, when the fluid demand from second circuit 78 is less than the fluid supplied to third circuit 82 by first circuit 74, spool element 134 of third control valve 122 may be moved to an in-between position, such that some fluid is directed to tank 112 and the remaining fluid is passed further along to second circuit 78. A similar situation may occur during discharge of fluid from second circuit 78 to third circuit 82.

In the disclosed hydraulic system, flows provided by the different pumps may be substantially unrestricted during modulation of the associated hydraulic actuators such that significant energy is not unnecessarily wasted in the actuation process. Thus, embodiments of the disclosure may provide improved energy usage and conservation. In addition, the closed-loop meterless operation of hydraulic system 72 may, in some applications, allow for a reduction or even complete elimination of metering valves for controlling fluid flow associated with the linear and rotary actuators. This reduction may result in a less complicated and/or less expensive system.

The disclosed hydraulic system may also provide for fluid power recuperation and reuse between multiple, closed-loop circuits. That is, the configuration of hydraulic system 72 may allow for excess fluid power from one closed-loop circuit to be recuperated or used within another closed-loop circuit.

It will be apparent to those skilled in the art that various modifications and variations can be made to the disclosed hydraulic system. Other embodiments will be apparent to those skilled in the art from consideration of the specification and practice of the disclosed hydraulic system. For example, it is contemplated that control valves 94, 107, and/or 122 may embody non-spool type valves and/or non-pilot operated types of valves, if desired. For example, direct solenoid operated valves having poppet-type elements may be utilized. It is intended that the specification and examples be considered as exemplary only, with a true scope being indicated by the following claims and their equivalents.

What is claimed is:

1. A hydraulic system, comprising:
a unidirectional variable displacement first pump;
a first hydraulic actuator connected to the first pump via a closed-loop first circuit;
a unidirectional variable displacement second pump;
a second hydraulic actuator connected to the second pump via a closed-loop second circuit;
a third pump selectively connectable in closed-loop manner to the first or second circuits; and
a first valve disposed between the first hydraulic actuator and the first pump and configured to selectively direct fluid from the first circuit to the second and third pumps.

2. The hydraulic system of claim 1, wherein the first valve is movable between a first position at which all of the fluid within the first circuit is directed through the first hydraulic actuator in a first direction, a second position at which all of the fluid in the first circuit bypasses the first hydraulic actuator, and a third position at which all of the fluid in the first circuit is directed through the first hydraulic actuator in a second direction.

3. The hydraulic system of claim 2, further including a second valve disposed between the second hydraulic actuator and the second pump and configured to selectively direct fluid from the second circuit to the first and third pumps.

4. The hydraulic system of claim 3, wherein the second valve is movable between a first position at which all of the fluid within the second circuit is directed through the second hydraulic actuator in a first direction, a second position at which all of the fluid in the second circuit bypasses the second hydraulic actuator, and a third position at which all of the fluid in the second circuit is directed through the second hydraulic actuator in a second direction.

5. The hydraulic system of claim 4, further including a third valve disposed between the third pump and the first and second circuits, the third valve being movable between a first position at which all of the fluid from the third pump is directed into the first circuit, a second position at which all of the fluid flow from the third pump is directed into a low-pressure tank to recuperate energy from the fluid, and a third position at which all of the fluid from the third pump is directed into the second circuit.

6. The hydraulic system of claim 5, wherein the first, second, and third valves are three-position, four-way valves.

7. The hydraulic system of claim 5, wherein each of the first, second, and third valves are pilot operated and variable position.

8. The hydraulic system of claim 5, further including a fourth valve configured to selectively connect the first circuit with the third pump and the second circuit.

9. The hydraulic system of claim 8, further including a fifth valve configured to selectively connect the second circuit with the third pump and the first circuit.

10. The hydraulic system of claim 9, further including first, second, and third check valves associated with discharge passages of the first, second, and third pumps, respectively.

11. The hydraulic system of claim 1, wherein the first and second hydraulic actuators are linear actuators.

12. The hydraulic system of claim 11, wherein:
the first hydraulic actuator is a boom actuator; and
the second hydraulic actuator is a stick actuator.

13. A hydraulic system, comprising:
a unidirectional variable displacement first pump;
a boom actuator connected to the first pump via a closed-loop first circuit;
a unidirectional variable displacement second pump;
a stick actuator connected to the second pump via a closed-loop second circuit;
a third pump selectively connectable in closed-loop manner to the first or second circuits;
a first valve disposed between the boom actuator and the first pump and configured to selectively direct fluid from the first circuit to the second and third pumps;
a second valve disposed between the stick actuator and the second pump and configured to selectively direct fluid from the second circuit to the first and third pumps;
a third valve disposed between the third pump and the first and second circuits, the third valve being movable between a first position at which all of the fluid from the third pump is directed into the first circuit, a second position at which all of the fluid flow from the third pump is directed into a low-pressure tank, and a third position at which all of the fluid from the third pump is directed into the second circuit;
a fourth valve configured to selectively connect the first circuit with the third pump and the second circuit; and
a fifth valve configured to selectively connect the second circuit with the third pump and the first circuit.

14. A method of operating a hydraulic system, comprising:
pressurizing fluid with a first pump;
directing pressurized fluid from the first pump to a first hydraulic actuator via a closed-loop first circuit;
pressurizing fluid with a second pump;
directing pressurized fluid from the second pump to a second hydraulic actuator via a closed-loop second circuit;
pressurizing fluid with a third pump;
selectively directing pressurized fluid from the third pump to the first or second circuits in closed-loop manner; and
selectively directing fluid from the first circuit to the second and third pumps.

15. The method of claim 14, further including selectively directing fluid from the first pump through the first hydraulic actuator in a first direction, from the first pump through the first hydraulic actuator in a second direction, and from the first pump to bypass the first hydraulic actuator.

16. The method of claim 15, further including selectively directing fluid from the second circuit to the first and third pumps.

17. The method of claim 16, further including selectively directing fluid from the second pump through the second hydraulic actuator in a first direction, from the second pump through the second hydraulic actuator in a second direction, and from the second pump to bypass the second hydraulic actuator.

18. The method of claim 17, further including selectively directing fluid from the third pump into a low-pressure tank to recuperate energy from the fluid.

19. The method of claim 17, further including selectively connecting a discharge passage of the first circuit with an intake passage of only the third pump or intake passages of both the second and third pumps.

20. The method of claim 19, further including selectively connecting a discharge passage of the second circuit with an intake passage of only the third pump or intake passages of both the first and third pumps.
